(19) United States
(12) Patent Application Publication
(10) Pub. No.: US 2026/0307634 A1
(43) Pub. Date: Oct. 8, 2026

(54) COMPRESSED-AIR BRAKE DEVICE, AND MOTOR VEHICLE COMPRISING SUCH A COMPRESSED-AIR BRAKE DEVICE

(71) Applicant: Daimler Truck AG, Leinfelden-Echterdingen (DE)

(72) Inventor: Michael SCHWALL, Jockgrim (DE)

(21) Appl. No.: 19/483,337

(22) PCT Filed: May 2, 2024
(86) PCT No.: PCT/EP2024/062107

§ 371 Date: Nov. 11, 2025

(30) Foreign Application Priority Data
May 12, 2023 (DE) 10 2023 112 642.3

(51) Int. Cl. B60T 13/68; B60T 8/94; B60T 13/24

(52) U.S. Cl. CPC B60T 13/683; B60T 8/94; B60T 13/24

(57) ABSTRACT

The invention relates to a compressed-air brake device (1) for a motor vehicle, in particular a utility vehicle, with a pneumatic front axle brake circuit (3) and at least one pneumatic rear axle brake circuit (5), wherein a first valve device (7.1) is arranged fluidically between the front-axle brake circuit (3) and the rear-axle brake circuit (5), the first valve device being configured to be switched from a normal state in which the rear-axle brake circuit (5) is fluidically separated from the front-axle brake circuit (3) to a failure state in response to a trigger signal, wherein in the failure state the rear-axle brake circuit (5) is fluidically connected to the front-axle brake circuit (3) in such a way that the rear-axle brake circuit (5) can be supplied with supply air fed from the front-axle brake circuit (5) as failure brake air for the pneumatic braking of at least one rear axle.

The invention relates to a compressed-air brake device and a motor vehicle with such a compressed-air brake device.

It is known that motor vehicles, in particular commercial vehicles, have at least two brake circuits, wherein a front axle brake circuit is assigned to a front axle and a rear axle brake circuit is assigned to a rear axle. Even if one brake circuit fails, it is necessary that the motor vehicle can be braked reliably and safely by means of the other brake circuit. In particular, a minimum deceleration of 2.2 m/s² must be ensured at all times for commercial vehicles. If one brake circuit fails, the remaining brake circuit is in most cases not sufficient to achieve the minimum deceleration and thus to ensure safe and reliable braking. In order to achieve the minimum deceleration in the event of a brake circuit failure, the parking brake is used to generate an additional deceleration, in particular by venting a spring accumulator in a brake cylinder. The disadvantage is that the additional deceleration can only be set and/or dosed imprecisely by means of the parking brake, so that either the additional deceleration is too little, or is provided too slowly or too quickly. If the additional deceleration is too little, or the additional deceleration is provided too slowly, braking cannot be carried out safely and quickly. If the additional deceleration is provided too quickly, the wheels braked in this way lock, and safe braking is also not possible.

The invention is therefore based on the object of creating a compressed-air brake device and a motor vehicle with such a compressed-air brake device, wherein the aforementioned disadvantages are at least partially eliminated, preferably avoided.

The object is achieved by providing the present technical teaching, in particular the teaching of the independent claims as well as the embodiments disclosed in the dependent claims and the description.

The object is achieved, in particular, by creating a compressed-air brake device for a motor vehicle, in particular a commercial vehicle, with a pneumatic front axle brake circuit and at least one pneumatic rear axle brake circuit. In the process, a first valve device is arranged fluidically between the front axle brake circuit and the rear axle brake circuit. The first valve device is configured to be switched from a normal state in which the rear axle brake circuit is fluidically separated from the front axle brake circuit to a failure state in response to a trigger signal. In the process, in the failure state, the rear axle brake circuit is fluidically connected to the front axle brake circuit in such a way that the rear axle brake circuit can be supplied with supply air fed from the front axle brake circuit as failure brake air for pneumatic braking of at least one rear axle. Advantageously, in the event of a malfunction of the rear axle brake circuit the front axle brake circuit is used in order to use the failure brake air to ensure safe, in particular well-dosed or dosed, and reliable braking.

In one configuration, the trigger signal is a pressure difference and/or a change in the pressure difference between a failure brake air pressure of the failure brake air and a rear axle brake air pressure of the rear axle brake air.

The first valve device is preferably a shuttle valve. In particular, a first input of the shuttle valve is fluidically connected to the front axle brake circuit. In addition, in particular, a second input of the shuttle valve is fluidically connected to the rear axle brake circuit. Furthermore, in particular, an output of the shuttle valve is fluidically connected to at least one brake cylinder of the at least one rear axle of the motor vehicle. In particular, the shuttle valve has a switching device that is configured to fluidically connect the second input to the output in the normal state and to fluidically connect the first input to the output in the failure state.

Particularly preferably, the first valve device is biased, in particular the shuttle valve, in particular the switching device of the shuttle valve, in particular in the direction of the first input, so that the first valve device, in particular the shuttle valve, is in the normal state by default, in particular when no pressure is applied to the inputs.

In particular, the first valve device, in particular the shuttle valve, is configured in such a way that the first valve device, in particular the first shuttle valve, switches from the normal state to the failure state when the pressure difference is greater than zero, in particular greater than a first predetermined pressure difference threshold—in particular defined by the biasing. Alternatively or in addition, the first valve device, in particular the shuttle valve, is configured in such a way that the first valve device, in particular the shuttle valve, switches from the failure state to the normal state when the pressure difference is less than zero, in particular less than a second predetermined pressure difference threshold. Particularly preferably, the first predetermined pressure difference threshold and the second predetermined pressure difference threshold are identical. In particular, the first predetermined pressure difference threshold and the second predetermined pressure difference threshold are defined by the biasing of the switching device.

In particular, the first valve device is configured in such a way that when the rear axle brake air pressure drops due to a fault, in particular a leak, and thus braking of the rear axle is no longer reliably possible, the device switches from the normal state to the failure state, whereby at least one brake cylinder of the at least one rear axle is supplied with supply air fed from the front axle brake circuit as failure brake air for pneumatic braking.

According to a further development of the invention, the compressed-air brake device has a front axle air reservoir. The front axle air reservoir is fluidically connected to the first valve device in such a way that in the failure state the supply air from the front axle air reservoir is supplied to the rear axle brake circuit.

Preferably, the front axle air reservoir is fluidically connected to the first input of the shuttle valve.

In particular, the compressed-air brake device has a rear axle air reservoir. The rear axle air reservoir is fluidically connected to the first valve device in such a way that in the normal state the rear axle brake air is supplied to the rear axle brake circuit from the rear axle air reservoir. Preferably, the rear axle air reservoir is fluidically connected to the second input of the shuttle valve.

According to a further development of the invention, it is provided that a second valve device is arranged fluidically between the front axle brake circuit and the first valve device. The second valve device is configured to reduce the failure brake air pressure of the failure brake air for pneumatic braking between the first valve device and the second valve device as a function of a control pressure. Advantageously, this makes it possible to suitably set the failure brake air pressure so that locking of the rear axle is avoided.

In particular, the second valve device is configured to set the failure brake air pressure of the failure brake air for pneumatic braking between the first valve device and the second valve device as a function of the front axle brake air pressure of the front axle brake air for pneumatic braking in the front axle brake circuit.

The second valve device is preferably a first pressure control valve. In particular, an input of the first pressure control valve is fluidically connected to the front axle air reservoir. In addition, in particular, a control input of the first pressure control valve is fluidically connected to the front axle brake circuit. Furthermore, an outlet of the first pressure control valve is fluidically connected to the first valve device, in particular the first input of the shuttle valve. In particular, the front axle air reservoir has supply air with a supply air pressure, wherein the supply air pressure is greater than the front axle brake air pressure. In particular, this configures the first pressure control valve to set, in particular regulate, the failure brake air pressure of the failure brake air to the front axle brake air pressure.

According to a further development of the invention, it is provided that a third valve device is arranged fluidically between the front axle brake circuit and the first valve device. The third valve device is configured to limit a limited failure brake air pressure of the failure brake air for pneumatic braking between the first valve device and the third valve device to a predetermined limit pressure value. In particular, the third valve device generates a delayed pressure build-up of the failure brake air so that advantageously the rear axle is not braked abruptly and/or locking of the rear axle is avoided.

In particular, the third valve device is arranged fluidically between the first valve device and the second valve device.

In particular, the predetermined limit pressure value is at least 3.5 bar and at most 3.7 bar.

The third valve device is preferably a pressure-limiting valve. In particular, an output of the pressure-limiting valve is fluidically connected to the first valve device, in particular the first input of the shuttle valve. Furthermore, an input of the pressure-limiting valve, in particular in the absence of the second valve device, is fluidically connected to the front axle brake circuit or to the front axle air reservoir. Alternatively, the input of the pressure-limiting valve is fluidically connected to the second valve device, in particular the output of the first pressure control valve.

According to a further development of the invention, it is provided that a fourth valve device is arranged fluidically between the front axle brake circuit and the first valve device. The fourth valve device is operatively connected to a weight detection device. The weight detection device is configured to detect a weight acting on the at least one rear axle and, depending thereon, to transmit a weight signal to the fourth valve device. The fourth valve device is configured to set a weight-adjusted failure brake air pressure of the failure brake air for pneumatic braking between the fourth valve device and the first valve device as a function of the weight signal. Advantageously, this makes it possible, in particular, to reduce and/or avoid over-braking of the rear axle.

In particular, the fourth valve device is arranged fluidically between the first valve device and the second valve device, in particular between the first valve device and the third valve device.

The fourth valve device is preferably a second pressure control valve. In particular, an output of the second pressure control valve is fluidically connected to the first valve device, in particular the first input of the shuttle valve. Furthermore, an input of the second pressure control valve is fluidically connected to the front axle brake circuit or the front axle air reservoir, in particular in the absence of the second valve device and the third valve device. Alternatively, the input of the second pressure control valve is fluidically connected to the second valve device, in particular the output of the first pressure control valve, in particular in the absence of the third valve device. Alternatively, the input of the second pressure control valve is fluidically connected to the third valve device, in particular the output of the pressure-limiting valve. In particular, the second pressure control valve is configured to set, in particular regulate, the weight-adjusted failure brake air pressure of the failure brake air as a function of the weight signal.

In particular, the weight signal is a bellows pressure of an air suspension of at least one rear axle.

In particular, a control input of the second pressure control valve is subjected to the bellows pressure, wherein an over- or under-setting is optionally provided—in particular by selecting suitable valve surfaces—so that the weight-adjusted failure brake air pressure is not necessarily regulated directly to the bellows pressure, but can deviate from it upwards or downwards.

According to a further development of the invention, it is provided that a switching device is arranged fluidically between the front axle brake circuit and the second valve device. The switching device is configured to apply the front axle brake air pressure of the front axle brake air as control pressure to the second valve device, in particular the control input of the first pressure control valve, in response to a malfunction signal. This advantageously ensures that the front axle brake air pressure, as the control pressure, is only present at the second valve device, in particular at the control input, in the event of a malfunction. Furthermore, this also makes it possible to protect the other valve devices and, in particular, the first valve device from wear caused by high pressures. Furthermore, incorrect switching of the first valve device due to short-term pressure fluctuations, in particular incorrect switching from a normal state to a failure state, is advantageously avoided.

In particular, when the malfunction signal is present, the first valve device switches from the normal state to the failure state, in particular triggered by the pressure difference present at the first valve device.

In particular, the switching device has an electric switching valve and a control device, wherein the control device is operatively connected to a pressure sensor. The pressure sensor is, in particular, configured to determine the rear axle brake air pressure in the rear axle brake circuit. In particular, a pressure determined by the pressure sensor is used as a malfunction signal if the rear axle brake air pressure determined by means of the pressure sensor is less than a predetermined malfunction pressure threshold, wherein the predetermined malfunction pressure threshold is particularly preferably 0.5 bar. Alternatively, the malfunction signal is generated, in particular, if the rear axle brake air pressure is less than the predetermined malfunction pressure threshold. In this case, the control device switches the front axle brake air pressure to the control input of the first pressure control valve via the electric switching valve.

In particular, in the absence of the malfunction signal, the ambient pressure is present as control pressure at the second valve device, in particular at the control input of the first pressure control valve, in particular via the electrical switching valve.

According to a further development of the invention, the compressed-air brake device has a display device. The display device is connected to the switching device, in particular to the control device, and is configured to display a malfunction, in particular visually. Advantageously, this makes it possible to monitor a functioning of the rear axle brake circuit and to quickly recognize a malfunction.

In particular, the display device has an LED, wherein the LED lights up in the event of a malfunction, in particular in the presence of the malfunction signal.

According to a development of the invention, the compressed-air brake device has the first valve device as the first left valve device. The first left valve device is configured to fluidically connect the front axle brake circuit to a left brake cylinder of the at least one rear axle in the failure state so that the left brake cylinder can be supplied with supply air fed from the front axle brake circuit as failure brake air for pneumatic braking from the front axle brake circuit. In addition, the compressed-air brake device has an analogously designed and arranged first right valve device. The first right valve device is configured to fluidically connect the front axle brake circuit to a right brake cylinder of the at least one rear axle in the failure state so that the right brake cylinder can be supplied with supply air fed from the front axle brake circuit as failure brake air for pneumatic braking from the front axle brake circuit. This advantageously decouples the left and right brake cylinders. This means that safe and reliable braking is possible even if one of the brake cylinders is defective and/or is causing the rear axle brake circuit to malfunction.

In one configuration, the compressed-air brake device additionally has a second right valve device, and the second valve device as a second left valve device. The second right valve device is arranged fluidically between the front axle brake circuit—in particular the front axle air reservoir—and the first right valve device, and is configured to set a failure brake air pressure of the failure brake air between the first right valve device and the second right valve device as a function of the control pressure. The second left valve device is arranged fluidically between the front axle brake circuit—in particular the front axle air reservoir—and the first left valve device, and is configured to set a failure brake air pressure of the failure brake air between the first left valve device and the second left valve device as a function of the control pressure. In particular, the second right valve device and the second left valve device are designed and arranged analogously. Alternatively or additionally, the compressed-air brake device has a third right valve device, and the third valve device as a third left valve device. The third right valve device is arranged fluidically between the front axle brake circuit—in particular the front axle air reservoir—and the first right valve device, in particular between the first right valve device and the second right valve device, and is configured to limit the limited failure brake air pressure of the failure brake air between the first right valve device and the third right valve device to the predetermined limit pressure value. The third left valve device is arranged fluidically between the front axle brake circuit—in particular the front axle air reservoir—and the first left valve device, in particular between the first left valve device and the second left valve device, and is configured to limit the limited failure brake air pressure of the failure brake air between the first left valve device and the third left valve device to the predetermined limit pressure value. In particular, the third right valve device and the third left valve device are designed and arranged analogously. Alternatively or additionally, the compressed-air brake device has a fourth right valve device, and the fourth valve device as a fourth left valve device. The fourth right valve device is arranged fluidically between the front axle brake circuit—in particular the front axle air reservoir—and the first right valve device, in particular between the first right valve device and the third right valve device, and is operatively connected to a right weight detection device. The right weight detection device is configured to detect a weight acting on a right side of the at least one rear axle and, depending thereon, to transmit a right weight signal to the fourth right valve device. The fourth right valve device is configured to set a weight-adjusted failure brake air pressure of the failure brake air between the fourth right valve device and the first right valve device as a function of the right weight signal. The fourth left valve device is arranged fluidically between the front axle brake circuit—in particular the front axle air reservoir—and the first left valve device, in particular between the first left valve device and the third left valve device, and is operatively connected to a left weight detection device. The left weight detection device is configured to detect a weight acting on a left side of the at least one rear axle and, depending thereon, to transmit a left weight signal to the fourth left valve device. The fourth left valve device is configured to set a weight-adjusted failure brake air pressure of the failure brake air between the fourth left valve device and the first left valve device as a function of the left weight signal. In particular, the fourth right valve device and the fourth left valve device are designed and arranged analogously. Furthermore, in particular, the right weight detection device and the left weight detection device are also configured and designed analogously. Alternatively or additionally, the compressed-air brake device has the switching device, wherein the switching device is fluidically connected to the front axle brake circuit, the second right valve device and the second left valve device. The switching device is configured to apply the front axle brake air pressure of the front axle brake air as control pressure to the second right valve device and the second left valve device in response to the malfunction signal.

The object is also achieved in particular by providing a motor vehicle, in particular a commercial vehicle, with a compressed-air brake device according to the invention or a compressed-air brake device according to one or more of the previously explained configurations. In connection with the motor vehicle, the advantages that have already been explained in connection with the compressed-air brake device arise in particular.

The invention is explained in more detail below with reference to the drawing.

In the drawing:

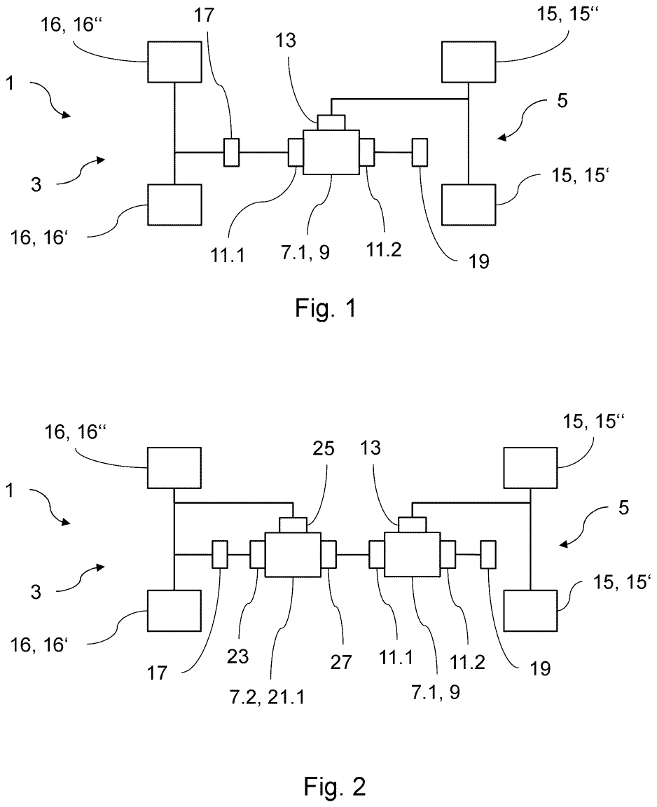

FIG. 1 shows a schematic representation of a first exemplary embodiment of a compressed-air brake device,

FIG. 2 shows a schematic representation of a second exemplary embodiment of the compressed-air brake device,

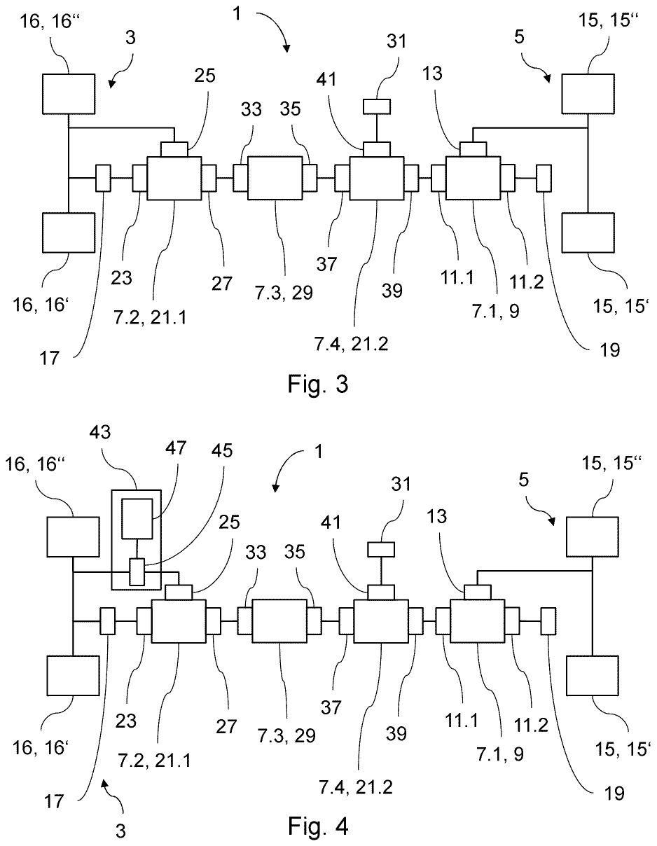

FIG. 3 shows a schematic representation of a third exemplary embodiment of the compressed-air brake device,

FIG. 4 shows a schematic representation of a fourth exemplary embodiment of the compressed-air brake device,

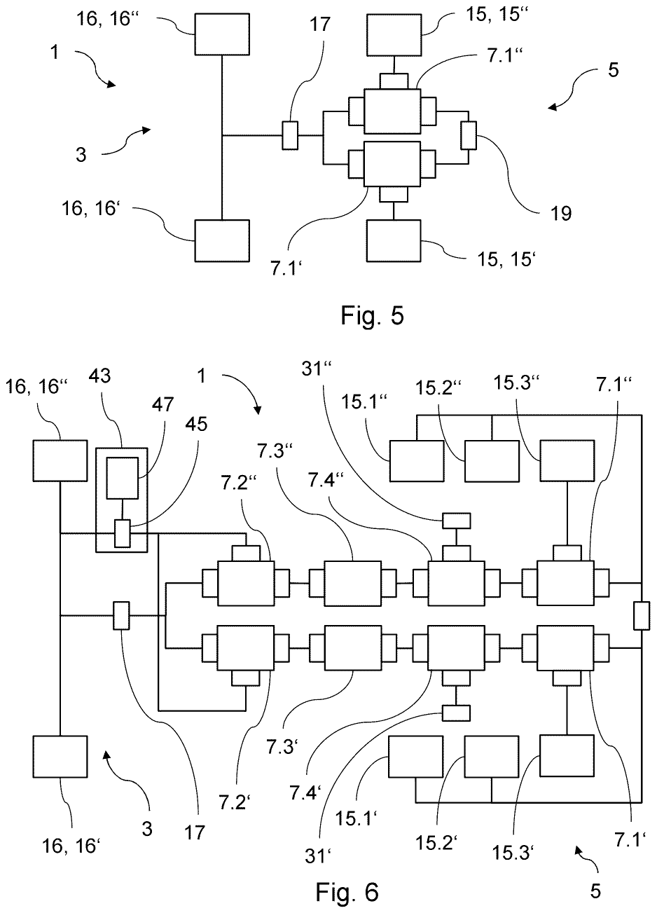

FIG. 5 shows a schematic representation of a fifth exemplary embodiment of the compressed-air brake device, and

FIG. 6 shows a schematic representation of a sixth exemplary embodiment of the compressed-air brake device.

In all of the following figures, a viewing direction of a compressed-air brake device 1 is selected in such a way that a front axle brake circuit 3 assigned to a front axle of a motor vehicle is shown on the left side and a rear axle brake circuit 5 assigned to a rear axle of the motor vehicle is shown on the right side. Furthermore, the viewing direction is selected in such a way that in a real world, the motor vehicle having the compressed-air brake device 1 is viewed from above, so that in the figures a right side of the compressed-air brake device 1 is shown at the top and a left side of the compressed-air brake device 1 is shown at the bottom.

FIG. 1 shows a schematic representation of a first exemplary embodiment of the compressed-air brake device 1 for the motor vehicle, in particular a commercial vehicle, with the pneumatic front axle brake circuit 3 and the at least one pneumatic rear axle brake circuit 5.

In the process, a first valve device 7.1 is arranged fluidically between the front axle brake circuit 3 and the rear axle brake circuit 5. The first valve device 7.1 is configured to be switched from a normal state in which the rear axle brake circuit 5 is fluidically separated from the front axle brake circuit 3 to a failure state in response to a trigger signal. In the process, in the failure state, the rear axle brake circuit 5 is fluidically connected to the front axle brake circuit 3 in such a way that the rear axle brake circuit 5 can be supplied with supply air fed from the front axle brake circuit 3 as failure brake air for the pneumatic braking of at least one rear axle.

Preferably, the first valve device 7.1 is a shuttle valve 9. In particular, a first input 11.1 of the shuttle valve 9 is fluidically connected to the front axle brake circuit 3. In addition, in particular, a second input 11.2 of the shuttle valve 9 is fluidically connected to the rear axle brake circuit 5. Furthermore, in particular an output 13 of the shuttle valve 9 is fluidically connected to at least one brake cylinder 15 of the at least one rear axle of the motor vehicle—in particular a left brake cylinder 15′ and a right brake cylinder 15″. In particular, the shuttle valve 9 has a switching device which is configured to fluidically connect the second input 11.2 to the output 13 in the normal state and to fluidically connect the first input 11.1 to the output 13 in the failure state.

In addition, the compressed-air brake device 1 has at least one brake cylinder 16 of a front axle, wherein the at least one brake cylinder 16 of the front axle—in particular a left brake cylinder 16′ and a right brake cylinder 16″—is supplied with brake air from the front axle brake circuit 3.

Optionally, the front axle brake circuit 3 has, in particular, a front axle air reservoir 17, wherein the at least one brake cylinder 16 of the front axle is fluidically connected to the front axle air reservoir 17. In particular, the first valve device 7.1, in particular the shuttle valve 9, in particular the first input 11.1 of the shuttle valve 9, is fluidically connected to the front axle air reservoir 17. Alternatively or additionally, the rear axle brake circuit 5 has, in particular, a rear axle air reservoir 19, wherein the first valve device 7.1, in particular the shuttle valve 9, in particular the second input 11.2 of the shuttle valve 9, is fluidically connected to the rear axle air reservoir 19.

In particular, a failure brake air with a failure brake air pressure, in particular from the front axle air reservoir 17, is present at the first valve device 7.1, in particular at the first input 11.1 of the shuttle valve 9. Furthermore, a rear axle brake air, in particular from the rear axle air reservoir 19, with a rear axle brake air pressure is present at the first valve device 7.1, in particular at the second input 11.2 of the shuttle valve 9. If a pressure difference between the failure brake air pressure of the failure brake air and the rear axle brake air pressure of the rear axle brake air is less than zero, in particular less than a first predetermined pressure difference threshold, the first valve device 7.1, in particular the first shuttle valve 9, is in the normal state so that the at least one brake cylinder 15 of the rear axle is supplied with the rear axle brake air for pneumatic braking of the at least one rear axle. If the pressure difference between the failure brake air pressure of the failure brake air and the rear axle brake air pressure of the rear axle brake air—in particular due to a leak in the rear axle brake circuit 5—rises above zero, and in particular becomes greater than the first predetermined pressure difference threshold, the first valve device 7.1, in particular the first shuttle valve 9, switches to the failure state so that the at least one brake cylinder 15 of the rear axle is supplied with the failure brake air for pneumatic braking of the at least one rear axle.

FIG. 2 shows a schematic representation of a second exemplary embodiment of the compressed-air brake device 1.

Identical and functionally equivalent elements are provided with the same reference symbols in all figures, so that reference is made to the preceding description.

The compressed-air brake device 1 according to FIG. 2 has, in addition to the compressed-air brake device 1 according to FIG. 1, a second valve device 7.2, in particular a first pressure control valve 21.1.

The second valve device 7.2, in particular the first pressure control valve 21.1, is arranged fluidically between the front axle brake circuit 3, in particular the front axle air reservoir 17, and the first valve device 7.1, in particular the shuttle valve 9. The second valve device 7.2, in particular the first pressure control valve 21.1, is configured to set the failure brake air pressure of the failure brake air for pneumatic braking between the first valve device 7.1, in particular the shuttle valve 9, and the second valve device 7.2, in particular the first pressure control valve 21.1, as a function of a control pressure, in particular the front axle brake air pressure of the front axle brake air, for pneumatic braking in the front axle brake circuit 3.

In particular, an input 23 of the first pressure control valve 21.1 is fluidically connected to the front axle air reservoir 17. In addition, a control input 25 of the first pressure control valve 21.1 is fluidically connected to the front axle brake circuit 3. Furthermore, an outlet 27 of the first pressure control valve 21.1 is fluidically connected to the first valve device 7.1, in particular the first input 11.1 of the shuttle valve 9.

In particular, supply air from the front axle air reservoir 17 is present at the input 23 of the pressure control valve 21.1 at a supply air pressure. In addition, the front axle brake air at the front axle brake air pressure is present at the control input 25 of the first pressure control valve 21.1, wherein the supply air pressure is greater than the front axle brake air pressure—in particular due to additional pneumatic valve devices which are not shown here. In particular, the failure brake air at the failure brake air pressure is present between the outlet 27 of the first pressure control valve 21.1 and the first valve device 7.1, in particular the shuttle valve 9. In particular, the first pressure control valve 21.1 is configured to set, in particular to regulate, the failure brake air pressure of the failure brake air to the front axle brake air pressure.

FIG. 3 shows a schematic representation of a third exemplary embodiment of the compressed-air brake device 1.

The compressed-air brake device 1 according to FIG. 3 has, in addition to the compressed-air brake device 1 according to FIG. 2, at least one further valve device selected from a third valve device 7.3, in particular a pressure-limiting valve 29, and a fourth valve device 7.4, in particular a second pressure control valve 21.2.

The third valve device 7.3, in particular the pressure-limiting valve 29, is arranged fluidically between the front axle brake circuit 3, in particular the second valve device 7.2, in particular the first pressure control valve 21.1, and the first valve device 7.1, in particular the shuttle valve 9. The third valve device 7.3, in particular the pressure-limiting valve 29, is configured to limit a limited failure brake air pressure of the failure brake air for pneumatic braking between the first valve device 7.1, in particular the shuttle valve 9, and the third valve device 7.3, in particular the pressure-limiting valve 29, to a predetermined limit pressure value, preferably 3.7 bar, particularly preferably 3.5 bar.

The fourth valve device 7.4, in particular the second pressure control valve 21.2, is arranged fluidically between the front axle brake circuit 3, in particular the second valve device 7.2 or the third valve device 7.3, in particular the pressure-limiting valve 29, and the first valve device 7.1, in particular the shuttle valve 9. The fourth valve device 7.4, in particular the second pressure control valve 21.2, is operatively connected to a weight detection device 31. The weight detection device 31, in particular an air suspension of the rear axle, is configured to detect a weight acting on the at least one rear axle and, depending thereon, to transmit a weight signal, in particular a bellows pressure of the air suspension, to the fourth valve device 7.4, in particular the second pressure control valve 21.2. The fourth valve device 7.4, in particular the second pressure control valve 21.2, is configured to set a weight-adjusted failure brake air pressure of the failure brake air for pneumatic braking between the fourth valve device 7.4, in particular the second pressure control valve 21.2, and the first valve device 7.1, in particular the shuttle valve 9, as a function of the weight signal.

In particular, an input 33 of the pressure-limiting valve 29 is fluidically connected to the second valve device 7.2, in particular the outlet 27 of the first pressure control valve 21.1. In addition, an outlet 35 of the pressure-limiting valve 29 is fluidically connected to the first valve device 7.1. Particularly preferably, the outlet 35 of the pressure-limiting valve 29 is fluidically connected to the fourth valve device 7.4, in particular an input 37 of the second pressure control valve 21.2. In particular, the failure brake air with the failure brake air pressure is present at the input 33 of the pressure-limiting valve 29, wherein the failure brake air pressure is regulated to the front axle brake air pressure. In particular, the failure brake air is present with a failure brake air pressure limited, in particular, to 3.7 bar, preferably to 3.5 bar, between the outlet 35 of the pressure-limiting valve 29 and the first valve device 7.1, in particular the shuttle valve 9.

In particular, the input 37 of the second pressure control valve 21.2 is fluidically connected to the second valve device 7.2, in particular the outlet 27 of the first pressure control valve 21.1. Particularly preferably, the input 37 of the second pressure control valve 21.2 is fluidically connected to the third valve device 7.3, in particular the outlet 35 of the pressure-limiting valve 29. In addition, an outlet 39 of the second pressure control valve 21.1 is fluidically connected to the first valve device 7.1, in particular the first input 11.1 of the shuttle valve 9. Furthermore, a control input 41 of the second pressure control valve 21.2 is fluidically connected to the weight detection device 31. In particular, the failure brake air with the limited failure brake air pressure is present at the input 37 of the second pressure control valve 21.2. In addition, the weight signal is present at the control input 41 of the second pressure control valve 21.2. In particular, the failure brake air with the weight-adjusted failure brake air pressure is present between the output 39 of the second pressure control valve 21.2 and the first valve device 7.1, in particular the first input 11.1 of the shuttle valve 9.

FIG. 4 shows a schematic representation of a fourth exemplary embodiment of the compressed-air brake device 1.

The compressed-air brake device 1 according to FIG. 4 has a switching device 43 in addition to the compressed-air brake device 1 according to FIG. 3.

The switching device 43 is arranged fluidically between the front axle brake circuit 3 and the second valve device 7.2, in particular the first pressure control valve 21.1. The switching device 43 is configured to apply the front axle brake air pressure of the front axle brake air as control pressure to the second valve device 7.2, in particular the control input 25 of the first pressure control valve 21.1, in response to a malfunction signal. In particular, when no malfunction signal is present at the switching device 43, ambient pressure is present as control pressure at the control input 25 of the first pressure control valve 21.1.

In particular, the malfunction signal is generated when the rear axle brake air pressure is less than a predetermined malfunction pressure threshold, wherein the predetermined malfunction pressure threshold is particularly preferably 0.5 bar.

Preferably, the switching device 43 has an electric switching valve 45 and a control device 47, wherein the control device 47 is operatively connected to a pressure sensor—not shown here. The pressure sensor is, in particular, configured to determine the rear axle brake air pressure in the rear axle brake circuit 5.

Optionally, the compressed-air brake device 1 additionally has a display device. The display device is connected to the switching device 43 and is configured to display a malfunction, in particular visually.

FIG. 5 shows a schematic representation of a fifth exemplary embodiment of the compressed-air brake device 1.

The compressed-air brake device 1 according to FIG. 5 has the first valve device 7.1 of the compressed-air brake device 1 according to FIG. 1 as a first left valve device 7.1′ and a first right valve device 7.1″.

For the sake of clear representation, the inputs and outputs of the valve devices 7 are not provided with reference symbols.

The first left valve device 7.1′ is configured to fluidically connect the front axle brake circuit to a left brake cylinder 15′ of the at least one rear axle in the failure state so that the left brake cylinder 15′ can be supplied with supply air fed from the front axle brake circuit 3 as failure brake air for pneumatic braking from the front axle brake circuit 3. The first right valve device 7.1″ is configured to fluidically connect the front axle brake circuit 3 to a right brake cylinder 15″ of the at least one rear axle in the failure state, so that the right brake cylinder 15″ can be supplied with supply air fed from the front axle brake circuit 3 as failure brake air for pneumatic braking from the front axle brake circuit 3.

FIG. 6 shows a schematic representation of a sixth exemplary embodiment of the compressed-air brake device 1.

The compressed-air brake device 1 has the front axle brake circuit 3 with at least one brake cylinder 16 of the front axle. Furthermore, the compressed-air brake device 1 also has the rear axle brake circuit 5. The rear axle brake circuit 5 is configured to brake a first rear axle, a second rear axle and a third rear axle. In particular, the first rear axle and the second rear axle are driven and the third rear axle is not driven. The rear axle brake circuit has a first left brake cylinder 15.1′ of the first rear axle, a first right brake cylinder 15.1″ of the first rear axle, a second left brake cylinder 15.2′ of the second rear axle, a second right brake cylinder 15.2″ of the second rear axle, a third left brake cylinder 15.3′ of the third rear axle and a third right brake cylinder 15.3″ of the third rear axle.

The compressed-air brake device 1 has the first left valve device 7.1′ and the first right valve device 7.1″ according to FIG. 5. In addition, the compressed-air brake device 1 has, in particular, a second left valve device 7.2′ and a second right valve device 7.2″. Alternatively or additionally, the compressed-air brake device 1 has a third left valve device 7.3′ and a third right valve device 7.3″. Alternatively or additionally, the compressed-air brake device 1 has in particular a fourth left valve device 7.4′, a fourth right valve device 7.4″, a left weight detection device 31′ and a right weight detection device 31″. Alternatively or additionally, the compressed-air brake device 1 has in particular the switching device 43 according to FIG. 4 and optionally the display device.

The first left valve device 7.1′ is fluidically connected to the rear axle air reservoir 19 and the third left brake cylinder 15.3′. The first right valve device 7.1″ is fluidically connected to the rear axle air reservoir 19 and the third right brake cylinder 15.3″. Furthermore, the first left valve device 7.1′ and the first right valve device 7.1″ are designed identically to the first valve device 7.1 according to FIGS. 1 to 4.

The second left valve device 7.2′ and the second right valve device 7.2″ are fluidically connected to the switching device 43. Furthermore, the second left valve device 7.2′ and the second right valve device 7.2″ are designed identically to the second valve device 7.2 according to FIGS. 2 to 4.

The third left valve device 7.3′ is arranged fluidically between the second left valve device 7.2′ and the fourth left valve device 7.4′. The third right valve device 7.3″ is arranged fluidically between the second right valve device 7.2″ and the fourth right valve device 7.4″. Furthermore, the third left valve device 7.3′ and the third right valve device 7.3″ are designed identically to the third valve device 7.3 according to FIGS. 3 and 4.

The fourth left valve device 7.4′ is arranged fluidically between the third left valve device 7.3′ and the first left valve device 7.1′. The fourth right valve device 7.4″ is arranged fluidically between the third right valve device 7.3″ and the first right valve device 7.1″. In addition, the fourth left valve device 7.4′ is operatively connected to the left weight detection device 31′. Furthermore, the fourth right valve device 7.4″ is operatively connected to the right weight detection device 31″. The fourth left valve device 7.4′ and the fourth right valve device 7.4″ are identical to the fourth valve device 7.4 according to FIGS. 3 and 4. In addition, the left weight detection device 31′ is configured to detect a weight acting on a left side of the at least one rear axle and, depending thereon, to transmit a left weight signal to the fourth left valve device 7.4′. In addition, the right weight detection device 31″ is configured to detect a weight acting on a right side of the at least one rear axle and, depending thereon, to transmit a right weight signal to the fourth right valve device 7.4″.

In particular, the front axle brake air in the front axle brake circuit 3 has the front axle brake air pressure p_{V}. Furthermore, the supply air in the front axle air reservoir 17 has the supply air pressure p_{VV}. The rear axle brake air in the rear axle brake circuit 5 has the rear axle brake air pressure p_{H}. The front axle brake air pressure p_{V} is therefore present at the switching device 43. Furthermore, the rear axle brake air pressure p_{H} is present at the second input 11.2 of the first left valve device 7.1′ and at the second input 11.2 of the first right valve device 7.1″. Furthermore, the switching device 43 has the malfunction pressure threshold p_{F}, wherein, in particular, P_{F}=0.5 bar applies.

In a first operating state of the compressed-air brake device 1, the rear axle brake circuit functions without a problem and p_{H}>p_{F} applies. This means that no malfunction signal is generated and the switching device 43 does not pass the front axle brake air on to the control inputs 25 of the second valve devices 7.2. The ambient pressure p_{U} is therefore present at the control inputs 25. The supply air is passed on by the second valve devices 7.2 as failure brake air, wherein the failure brake air pressure p_{A} corresponds to the ambient pressure p_{U}. The third valve devices 7.3 and fourth valve devices 7.4 pass the failure brake air with the ambient pressure on to the first inputs 11.1 of the first valve devices 7.1. If p_{U}=p_{A}≤p_{H}+Δp_{D}, wherein Δp_{D} is the predetermined pressure difference threshold and Δp_{D}>0, the first valve devices 7.1 are in the normal state, wherein the second input 25 of the first left valve device 7.1′ is fluidically connected to the third left brake cylinder 15.3′ and the second input 25 of the first right valve device 7.1″ is fluidically connected to the third right brake cylinder 15.3″, so that the rear axle brake air is used for braking with the third brake cylinders 15.3′ and 15.3″. If p_{U}=p_{A}>p_{H}+Δp_{D}, the first valve devices 7.1 are in the failure state, wherein the first input 25 of the first left valve device 7.1′ is fluidically connected to the third left brake cylinder 15.3′ and the first input 25 of the first right valve device 7.1″ is fluidically connected to the third right brake cylinder 15.3″, so that the failure brake air is used for braking with the third brake cylinders 15.3′ and 15.3″. In particular, when the rear axle brake circuit functions smoothly, the rear axle brake air pressure p_{H} is greater than the ambient pressure p_{U}, so that the first valve devices 7.1 are operated in the normal state.

In a second operating state of the compressed-air brake device 1, p_{H}<p_{F} applies, in particular due to a leak in the rear axle brake circuit. This generates a malfunction signal and the switching device 43 passes the front axle brake air on to the control inputs 25 of the second valve devices 7.2. The front axle brake air pressure p_{V} is therefore present at the control inputs 25. The supply air is passed on by the second valve devices 7.2 as failure brake air, wherein the failure brake air pressure p_{A} is regulated to the front axle brake air pressure p_{V}, so that between the second valve devices 7.2 and the third valve devices 7.3, p_{A}=p_{V} applies. The third valve devices 7.3 limit the failure brake air pressure p_{A} to 3.7 bar, in particular to 3.5 bar, so that between the third valve devices 7.3 and the fourth valve devices, 7.4 p_{A}=3.7 bar, in particular p_{A}=3.5 bar, applies. The fourth valve devices 7.4 regulate the failure brake air pressure p_{A} as a function of the weight signals of the weight detection devices 31, so that the failure brake air, with p_{A}≤3.7 bar, in particular p_{A}≤3.5 bar, is present at the first inputs 11.1 of the first valve devices 7.1. In particular, the fourth valve devices 7.4 regulate the failure brake air pressure in such a way that p_{A}>p_{F} applies. If 3.7 bar≥p_{A}≤p_{H}+Δp_{D} applies, in particular 3.5 bar>p_{A}≤p_{H}+Δp_{D}, the first valve devices 7.1 are in the normal state, wherein the second input 25 of the first left valve device 7.1′ is fluidically connected to the third left brake cylinder 15.3′ and the second input 25 of the first right valve device 7.1″ is fluidically connected to the third right brake cylinder 15.3″, so that the rear axle brake air is used for braking with the third brake cylinders 15.3′ and 15.3″. If 3.7 bar≥p_{A}>p_{H}+Δp_{D} applies, in particular 3.5 bar≥p_{A}>p_{H}+Δp_{D}, the first valve devices 7.1 are in the failure state, wherein the first input 25 of the first left valve device 7.1′ is fluidically connected to the third left brake cylinder 15.3′ and the first input 25 of the first right valve device 7.1″ are fluidically connected to the third right brake cylinder 15.3″, so that the failure brake air for braking with the third brake cylinders 15.3′ and 15.3″. In particular, the malfunction pressure threshold p_{F}, the predetermined pressure difference threshold Δp_{D}, and a maximum reduction of the failure brake air pressure by means of the fourth valve devices 7.4 are coordinated with one another in such a way that when a malfunction signal is generated, the first valve devices 7.1 are in the failure state.

1. A compressed-air brake device (1) for a motor vehicle, in particular a commercial vehicle, with a pneumatic front axle brake circuit (3) and at least one pneumatic rear axle brake circuit (5), wherein
a first valve device (7.1) is arranged fluidically between the front axle brake circuit (3) and the rear axle brake circuit (5), the first valve device being configured to be switched from a normal state in which the rear axle brake circuit (5) is fluidically separated from the front axle brake circuit (3) to a failure state in response to a trigger signal, wherein in the failure state the rear axle brake circuit (5) is fluidically connected to the front axle brake circuit (3) in such a way that the rear axle brake circuit (5) can be supplied with supply air fed from the front axle brake circuit (5) as failure brake air for the pneumatic braking of at least one rear axle.

2. The compressed-air brake device (1) according to claim 1, with a front axle air reservoir (17), wherein the front axle air reservoir (17) is fluidically connected to the first valve device (7.1) in such a way that in the failure state the supply air from the front axle air reservoir (17) is supplied to the rear axle brake circuit (5).

3. The compressed-air brake device (1) according to claim 1, wherein a second valve device (7.2) is arranged fluidically between the front axle brake circuit (3) and the first valve device (7.1), the second valve device being configured to set a failure brake air pressure of the failure brake air between the first valve device (7.1) and the second valve device (7.2) as a function of a control pressure, in particular a front axle brake air pressure of the front axle brake air in the front axle brake circuit (3).

4. The compressed-air brake device (1) according to claim 1, wherein a third valve device (7.3) is arranged fluidically between the front axle brake circuit (3) and the first valve device (7.1), in particular between the first valve device (7.1) and the second valve device (7.2), the third valve device being configured to limit a limited failure brake air pressure of the failure brake air between the first valve device (7.1) and the third valve device (7.3) to a predetermined limit pressure value.

5. The compressed-air brake device (1) according to claim 1, wherein
a fourth valve device (7.4) is arranged fluidically between the front axle brake circuit (3) and the first valve device (7.1), in particular between the first valve device (7.1) and the third valve device (7.3), wherein
the fourth valve device (7.4) is operatively connected to a weight detection device (31), wherein
the weight detection device (31) is configured to detect a weight acting on the at least one rear axle and, depending thereon, to transmit a weight signal to the fourth valve device (7.4), and wherein
the fourth valve device (7.4) is configured to set a weight-adjusted failure brake air pressure of the failure brake air between the fourth valve device (7.4) and the first valve device (7.1) as a function of the weight signal.

6. The compressed-air brake device (1) according to claim 1, wherein a switching device (43) is arranged fluidically between the front axle brake circuit (3) and the second valve device (7.2), the switching device being configured to apply the front axle brake air pressure of the front axle brake air as a control pressure to the second valve device (7.2) in response to a malfunction signal.

7. The compressed-air brake device (1) according to claim 1, with a display device, wherein the display device is connected to the switching device (43), and wherein the display device is configured to display a malfunction, in particular visually.

8. The compressed-air brake device (1) according to claim 1, with
the first valve device (7.1) as a first left valve device (7.1′) configured to fluidically connect the front axle brake circuit (3) to a left brake cylinder (15′) of the at least one rear axle in the failure state so that the left brake cylinder (15′) can be supplied with supply air fed from the front axle brake circuit (3) as failure brake air for pneumatic braking,
a first right valve device (7.1″) which is configured to fluidically connect the front axle brake circuit (3) to a right brake cylinder (15″) of the at least one rear axle in the failure state so that the right brake cylinder (15″) can be supplied with supply air fed from the front axle brake circuit (3) as failure brake air for pneumatic braking.

9. A motor vehicle with a compressed-air brake device (1) according to claim 1.
